(19) United States
(12) Patent Application Publication
(10) Pub. No.: US 2026/0236968 A1
(43) Pub. Date: Aug. 13, 2026

(54) System and Method for Personal Data Collection, Management, and Monetization

(71) Applicant: Daniel Seikon Park, Encino, CA (US)

(72) Inventor: Daniel Seikon Park, Encino, CA (US)

(21) Appl. No.: 19/050,947

(22) Filed: Feb. 11, 2025

(51) Int. Cl. G06Q 30/06

(52) U.S. Cl. CPC G06Q 30/06

(57) ABSTRACT

The present invention provides a system for personal data collection, management, and monetization. Users generate personal data through journaling applications and data capture devices, which is then processed by an AI-assisted module that categorizes and structures the data. The system enables secure storage with encryption and blockchain authentication, ensuring compliance with data protection regulations. Users can monetize their structured data through a transaction platform offering licensing, subscription-based models, or one-time sales. Privacy is maintained through anonymization and user-defined consent mechanisms, giving users control over data sharing. Unlike traditional data aggregation models, this invention empowers users with transparency and fair compensation for their data. The system integrates AI-based behavioral analysis, decentralized storage, and smart contracts to facilitate ethical data transactions. This novel approach enhances data reliability, security, and user engagement, transforming personal data into a valuable asset for both individuals and data buyers.

### BACKGROUND OF THE INVENTION

The need for a system and method for personal data collection, management, and monetization arises from the lack of mechanisms in existing systems to allow users to monetize the data they accumulate. While current journaling applications and systems, such as Apple's Journal app and those described in patents like U.S. Pat. No. 8,316,046 and US 20240264719A1, provide many ways to collect and access personal information, they do not provide users with opportunities to derive economic value from their data. Users remain passive contributors, unable to capitalize on the significant value their data represents, despite the growing economic importance of personal information in consumer analytics and targeted advertising. Therefore, an enhanced solution is needed that not only facilitates the collection and secure management of personal data but also empowers users to monetize their data, ensuring fair compensation and enhanced privacy protection.

In today's data-driven economy, personal data plays a significant role in consumer analytics, targeted advertising, and various other applications. More specifically, the value of personal information cannot be overstated. From purchasing behavior to health records, data collectors, data brokers, and data purchasers are buying, selling, and brokering this information, creating a multi-billion-dollar industry. However, despite being the originators of such data, users are often inadequately rewarded, if rewarded at all, for providing this invaluable information to large corporations. The issue is compounded by the poor quality of the data being transacted. Users typically do not put much effort into generating the data, leading to suboptimal quality.

Personal data privacy is another major concern in today's digital age. Users often share their valuable and private information unintentionally, without consent, and have no control over who accesses it, leaving them vulnerable to misuse and data breaches. These challenges make it necessary to rethink the way data is generated, collected, shared, protected, and rewarded.

Journal entries provide a good source of personal data accumulation, which can be stored, analyzed, and shared. Apple's Journal app, released in December 2023 with iOS 17.2, is a digital diary application designed to help users make journal entries for various purposes. The Journal app allows users to capture everyday moments using text, photos, videos, audio recordings, and location data while providing AI-powered suggestions for writing prompts based on the user's activities. The data generated and accumulated from these journal entries can be valuable not only for users but also for data collectors.

U.S. Pat. No. 8,316,046, titled “Journaling on Mobile Devices,” describes a journaling subsystem on mobile devices that collects and stores event data from various applications and subsystems (e.g., GPS, messaging, and camera). The stored data is indexed in a journal database, allowing the user to reconstruct a timeline of past events. The system also features search functionalities that provide users with location-based and timestamp-based access to the collected event data.

US Patent Application 20240264719A1, entitled “User Interfaces for Creating Journal Entries,” describes a journaling system that leverages AI to assist users in creating journal entries. The system employs AI-powered suggestions and prompts to guide users in documenting their experiences, using text, multimedia elements, and contextual data from mobile devices. The AI component plays a crucial role in analyzing user activities and providing personalized prompts to create detailed and context-rich journal entries.

Despite providing a robust way to collect and access personal information, the aforementioned systems lack mechanisms for data monetization, leaving users without opportunities to derive economic value from the data they accumulate. This highlights the need for enhanced personal data management solutions, as addressed in the present invention.

While US20210182915A1 discloses a system for monetizing user data through automated tokenization and blockchain-based transactions, it limits user control, data customization, and monetization flexibility as US20210182915A1 focuses on passive data vending and prioritizes token exchange.

The present invention seeks to move beyond conventional data-gathering models. It introduces a more holistic, user-centric approach that acknowledges personal data as an asset deserving both protection and financial remuneration. This framework not only enhances trust and user engagement but also improves the overall ecosystem for data exchange, driving higher-quality contributions and delivering more value to all stakeholders involved.

### SUMMARY OF THE INVENTION

The present invention provides a system and method for the collection, management, and monetization of personal data. This invention is directed to an integrated system that allows users to generate and accumulate personal data through journaling and other data capture applications, store and manage that data securely, and monetize the data using a marketplace.

By integrating these various components, the present invention delivers a comprehensive, user-centric platform that not only facilitates the secure collection and management of personal data but also empowers users to unlock its economic potential. This approach enhances data quality, increases user engagement, and ultimately creates a more equitable data economy that benefits both individual users and data buyers. For data buyers, the present invention offers access to high-quality, consent-driven data that is accurate and ethically sourced. By ensuring that users have control over their data and are incentivized to provide complete and up-to-date information, the platform significantly improves data reliability and relevance. Bulk data purchases are often prone to including unnecessary or redundant data, leading to inefficiencies and increased processing costs. The present invention mitigates such issues by offering curated, user-consented data, ensuring that buyers acquire the information relevant to their needs, thereby optimizing value and reducing waste.

The present invention allows the user to classify or categorize the different types of data through the user's data entries. For example, the user may make journal entries by using an input device such as the user's computer or mobile device. The data entry by journaling may be performed through any suitable journal entry or note-taking application.

The type of data entered as journal entries may be any information that the user wishes to enter. For example, a journal entry may be a traditional journal entry such as a reflection of the user's recount of events and feelings, or it may be purpose-specific such as the user's exercise and workout information, nutritional and dietary information, and the user's biometric information including but limited to the user's weight, body fat content, blood pressure, and sleep quality information.

The user's journal entries may be assisted by prompts generated by the journal entry application. The user's journal entries may be assisted or supplemented by the data collected from the user's devices. For example, the user's mobile device may supply location information, photographs, and videos taken that day and prompt the user to include such information in the journal entry, or such information may be preset to be entered automatically as a journal entry. The user's biometric information gathered from the user's devices such as smartwatches may be fed to the journal entry. The user's journal entries relating to the user's financials such as the user's purchases and spending may be assisted or automated by tracking and gathering the user's credit card, mobile payment such as Apple Pay™ and PayPal™, and other payment applications, or scanning the receipts.

The present invention may incorporate artificial intelligence (AI) to enhance, categorize, analyze, and present the collected data. The system may employ AI, machine learning models, or other computational techniques to categorize data, identify patterns, and generate personalized insights. For example, AI can classify journal entries into thematic segments such as health, finance, or lifestyle and identify trends over time. Predictive analytics can provide users with personalized recommendations and forecasts based on their historical data.

Additionally, AI-driven data visualization tools can transform raw data into intuitive graphs, charts, and dashboards, making the information more accessible and valuable to potential buyers. These insights can be customized and packaged into data products that align with market demand, enabling data buyers to extract meaningful insights efficiently.

The system may incorporate privacy-preserving mechanisms, such as encryption, anonymization, access controls, or differential privacy techniques, to ensure user data remains secure while maintaining its analytical value.

The present invention streamlines the process of data generation, collection, categorization, analysis, curation, and monetization, enabling users to manage and capitalize on their personal data efficiently and securely.

### BRIEF DESCRIPTION OF DRAWINGS

FIG. 1 is a non-limiting exemplary system overview diagram that illustrates the overall architecture, depicting user devices, cloud-based data collecting and aggregation platform, data analysis layer, security, and data marketplace platform.

FIG. 2 is an exemplary flow diagram showing how data moves from user input (journal entry) to data processing system-assisted data categorization, data storage, and data retrieval.

FIG. 3 is an exemplary flow diagram showing how data is transacted between user and data buyer.

FIG. 4 is an exemplary flow diagram illustrating how subscription for curated user data is established and transacted between users and buyers.

FIG. 5 is an exemplary diagram illustration showing the journal system utilizing AI model.

### DETAILED DESCRIPTION OF THE INVENTION

Systems and methods for personal data collection, management, and monetization are provided. At least one user may generate personal data through interactions with journaling applications and data capture devices. The user data may be input into the journal system via a user interface, such as a journaling application, or may be automatically transferred from user devices. The journal system may analyze and categorize the received user data into thematic segments, structuring categorized data to provide meaningful insights to the user. The categorized data may be transacted between the user and data buyers. The transaction formats may include, but are not limited to, licensing, subscription-based models, and one-time purchase arrangements. To ensure privacy and security, the journal system may implement security measures, including encryption, anonymization, and user-defined data access controls, throughout the processes of data generation, analysis, categorization, and transaction. Additionally, the journal system may incorporate consent management mechanisms, allowing users to regulate and control the sharing of their data with buyers in compliance with relevant data protection laws and best practices.

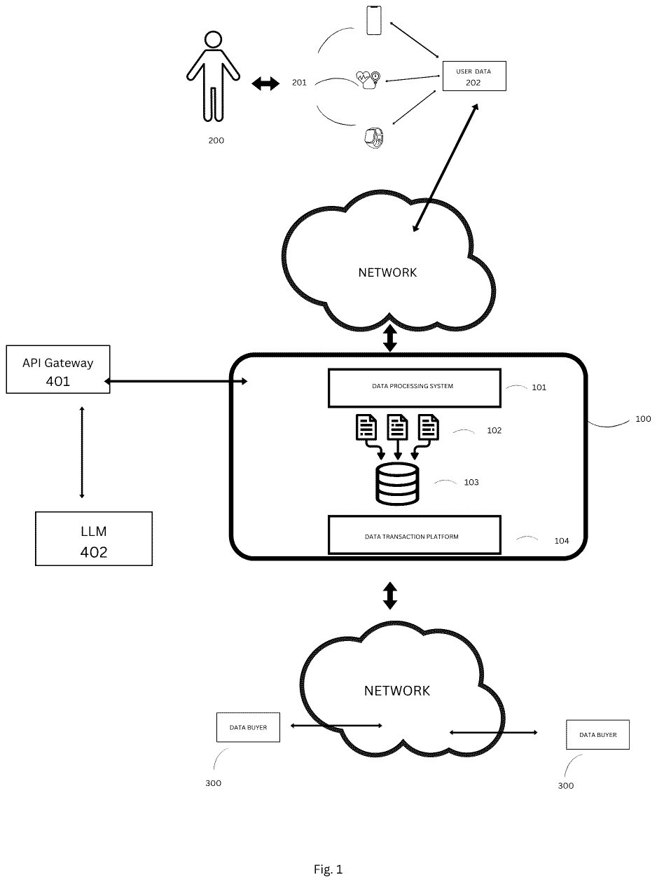

FIG. 1 illustrates an exemplary environment for generating, aggregating, managing, and monetizing user data. One or more users 200 with user device 201, are coupled to a journal system 100. According to a non-limiting exemplary embodiment, at least one user 200 may make journal entries by using, preferably, a dedicated journal entry application; however, any journal entry app such as Apple Journal app, or any other suitable applications such as note taking apps available on the user device 201 may be used to make journal entry. The user's journal entries may include any type of information that the user wishes to enter such as the user's mood, description of events that the user experienced, the dreams the user had, fitness and exercise information, food, medication, and supplement intakes, etc. The user's journal entries may be assisted by prompts, questions and suggestions generated from the journal entry application. The user's journal entries may include or be supplemented by the data collected or tagged from various user devices 201, including but not limited to smartphones equipped with motion sensors, GPS, and other relevant capabilities, wearables such as smartwatches and smart bands, which can measure heart rate, movement patterns, sleep quality, and other biometric or other information generated from the user, medical devices such as glucose monitors or blood pressure measurement devices, and IoT devices such as smart refrigerators, smart air conditioners, and smart home devices with data collecting capabilities. The user's photographs, videos, or other multimedia content collected from, or transmitted to the user devices 201 may be included in the user data. The user's financials such as the user's purchases and spending may be included in the user data, and such data collection may be assisted or automated by tracking and gathering the user's credit card, mobile payments such as Apple Pay™ and PayPal™, and other payment applications, or scanning the receipts. The user's journal entries may be made manually via the journal entry app, or may be made automatically from the user device 201, into the journal system 100. The user's journal entries may be made by any adequate input method including voicing, typing, pointing, or combinations thereof. The journal entry app is coupled to the journal system 100 preferably via a network, and the journal system 100 may be provided to users 200 as a web-based platform. However, the journal app and the journal system 100 may be provided as a stand-alone platform, localized on the user's computing devices such as the user's personal computer or smartphone.

The present invention may incorporate data processing system 101 to enhance the processing, categorization, analysis, and presentation of the collected data 102. By leveraging, preferably, AI-powered algorithms, the journal system 100 may be capable of automating complex data tasks, transforming raw data into meaningful insights, and improving the overall user experience. For example, journal entries may be sorted into thematic segments such as health, finance, lifestyle, or other user-defined categories. The journal system's semantic understanding may enable it to recognize context, intent, and content within the data, allowing contextually relevant classification, consistency, and scalability, making it easier for the users to retrieve and analyze their data.

The data processing system 101 may be equipped with pattern recognition capabilities to uncover meaningful relationships and trends within the user data 102. For example, it may be capable of identifying correlations between a user's dietary habits and biometric readings, such as heart rate or sleep patterns, to provide deeper insights. For example, by analyzing temporal patterns, the data processing system 101 may be able to detect recurring behaviors or anomalies over time, such as seasonal spending trends or changes in fitness routines. These insights are invaluable for users aiming to better understand and optimize their habits and decisions.

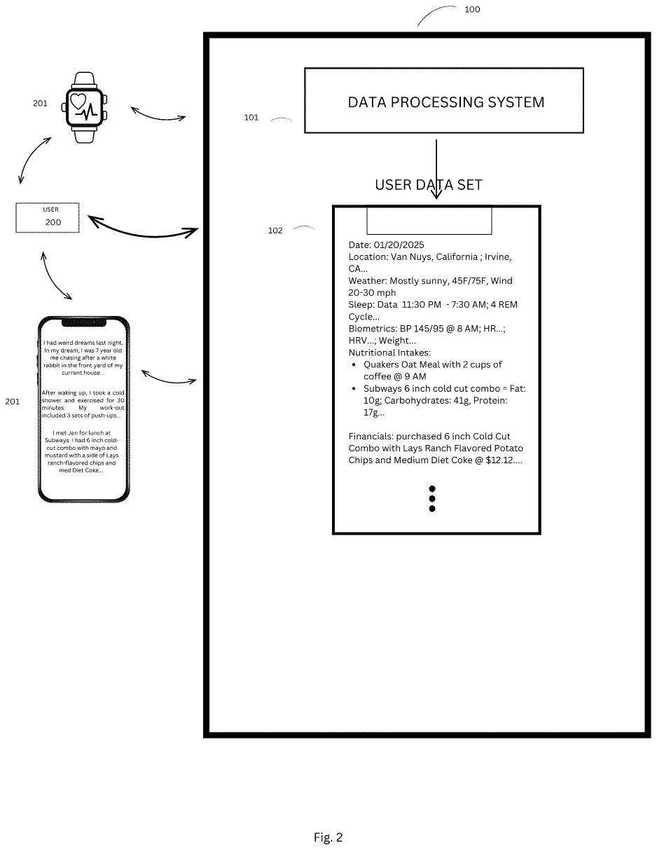

As shown in FIG. 2, the journal system 100 may leverage the data processing system 101 to generate insights tailored to individual user behavior and preferences. For example, it may analyze past fitness data to suggest optimal workout schedules or dietary adjustments. Similarly, it may evaluate financial spending patterns to recommend budgeting strategies. These insights are, preferably, presented through intuitive visualizations, such as graphs and dashboards, to enhance comprehension and usability. By analyzing historical data, the journal system 100 may be able to anticipate future trends and provide personalized forecasts.

The data processing system 101 may be capable of continually refining its analysis and recommendations through adaptive learning. As users interact with the system and provide feedback, the data processing system 101 may adjust its algorithms to better align with user preferences and goals.

The journal system 100 may utilize artificial intelligence (AI) techniques, including Retrieval-Augmented Generation (RAG) frameworks and large language models (LLMs), to enhance data categorization, curation, analysis, and monetization. AI integration may be structured via an API-based architecture, enabling real-time communication between the journal system 100 and the AI model 400, as depicted in FIG. 1, or the AI model may be locally deployed within the journal system 100. This AI-driven framework optimizes user data processing by facilitating efficient information retrieval and automated classification.

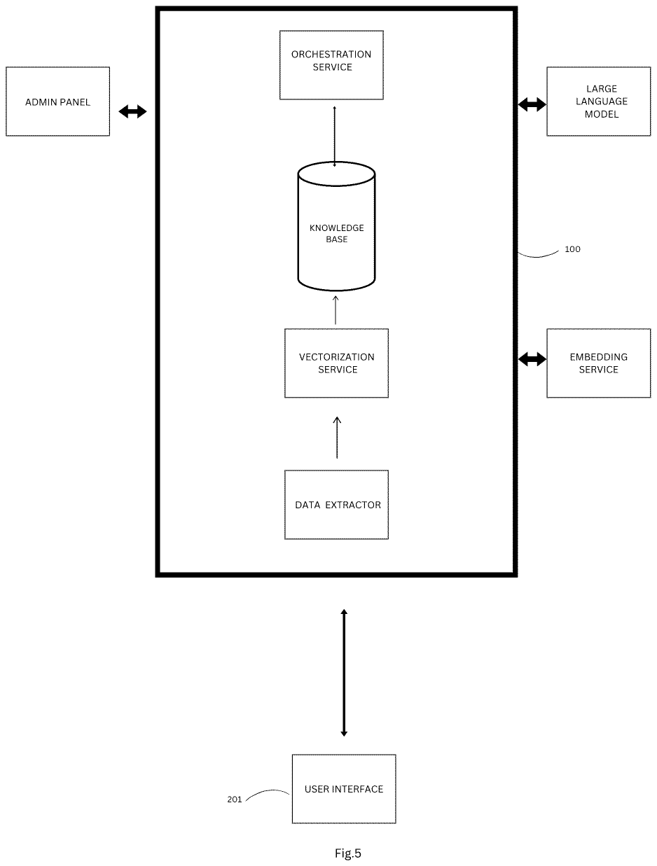

As shown in FIG. 5, the data processing system 101 may preprocess user data 202 before submitting it to an AI model for analysis. Preprocessing steps may include data extraction, segmentation, and vectorization, transforming raw journal entries into vector embeddings. The data processing system 101 may segment journal entries into discrete text chunks and generate vector representations using embedding services to capture semantic meaning.

Upon receiving data from user 200, the journal system 100 may classify journal entries leveraging an object-relational database management system, such as PostgreSQL, for vector similarity search or a graph database management system, such as Neo4J, for relationship-based analysis. Classification may utilize vector databases to enable semantic matching between journal entries 202 and predefined categories, as illustrated in FIG. 5.

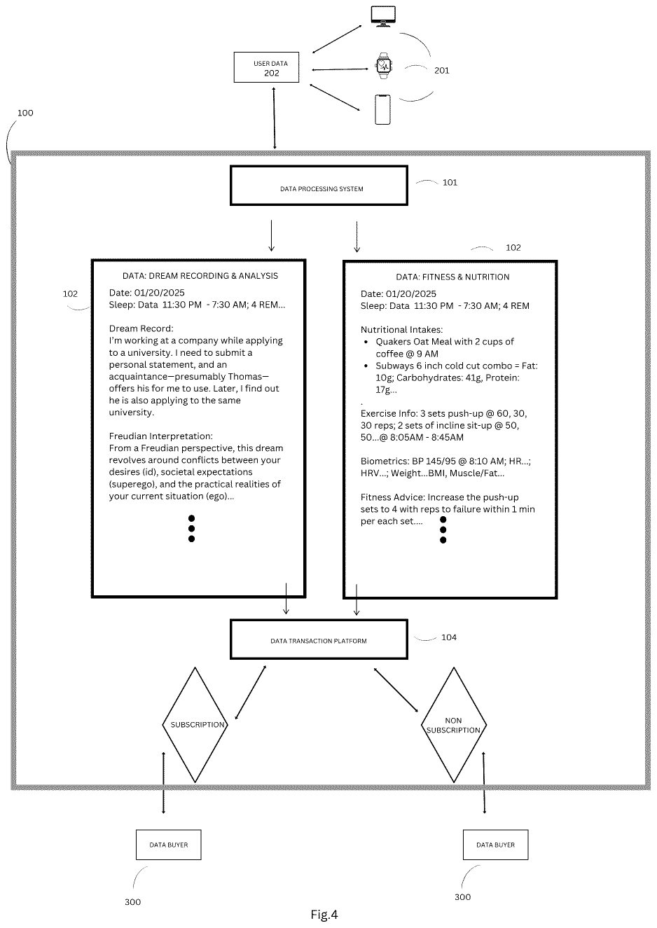

To support data curation, the journal system 100 may utilize an admin panel, as shown in FIG. 5, that allows monitoring and management of AI-generated outputs. As depicted in FIG. 4, this feature enhances data monetization by making curated datasets 102 interpretable and valuable to data buyers. The system may employ both vector and graph database approaches to optimize retrieval and relationship mapping.

Additionally, the journal system 100 may utilize an LLM module as a natural language processing engine for understanding and generating user responses. This module may integrate with various LLM providers, including OpenAI's ChatGPT, Amazon Bedrock, Azure AI-Language, and Google's Gemini, through a flexible abstraction layer to facilitate seamless provider switching without significant architectural changes.

As depicted in FIG. 5, the journal system 100 may implement a server-side application managing communication between the user interface and AI components. When users interact with their journal data, the application may send queries to the LLM module, which retrieves contextual information from the vector database to generate intelligent, structured responses. By incorporating AI-driven processing, the journal system 100 transforms raw user-generated data into a structured, monetizable asset, enhancing data quality, security, and utility.

The journal system 100 may also incorporate AI-based conversational interfaces, enabling users to interact with their journal data in natural language. Users may query their past journal entries, receive AI-generated insights, and automate structured journaling through AI-generated prompts. AI-driven interactive capabilities allow users to retrieve meaningful feedback and optimize their data management experience.

By integrating AI models, the journal system 100 may transform raw personal data into an intelligent, structured, and monetizable asset. Through automated categorization, predictive analytics, sentiment analysis, and AI-assisted user interactions, the system enhances data quality, ensures ethical monetization, and provides users with actionable insights while maintaining privacy and security.

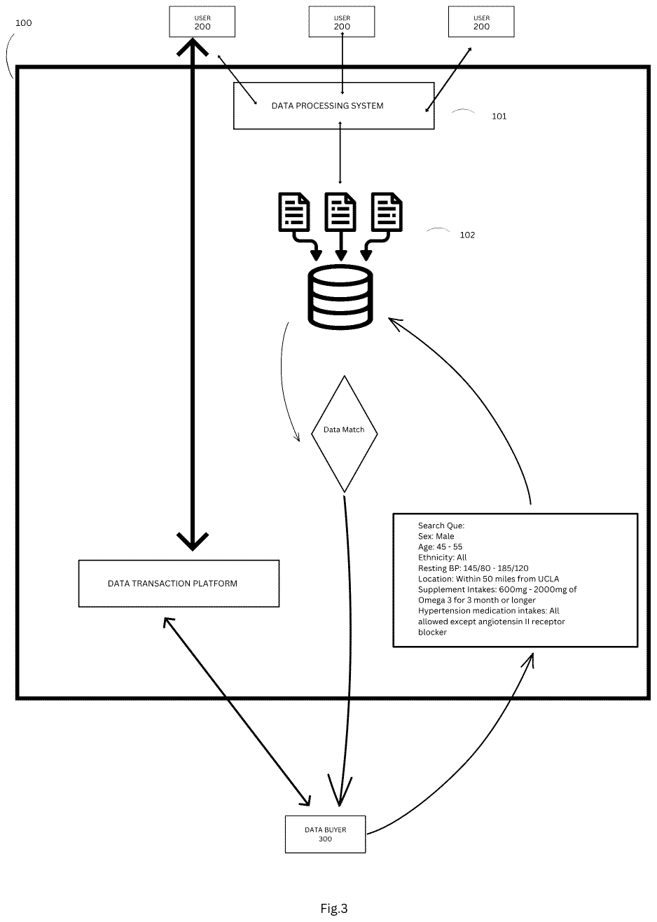

As shown in FIG. 3, the user data 202 may be analyzed and categorized to create a user dataset 102. The journal system 100 provides a platform for facilitating data transactions between users 200 and data buyers 300. The user dataset 102 may be searchable using various criteria. For example, as illustrated in FIG. 3, a data buyer 300, such as a research organization, may filter the database to identify users aged 50 to 60 with blood pressure measurements between 140/75 and 185/120, who also consume specific supplements.

Upon identifying relevant datasets, and with the data buyer's 300 interest in a specific dataset, the journal system 100 may facilitate the necessary consent process with the user. Users 200 may be notified of the buyer's interest and may choose to approve or deny the transaction. Following user consent, a tailored user dataset (not shown) may be securely transferred to the buyer 300, ensuring no additional or personally identifiable data is shared.

In one non-limiting exemplary embodiment, the journal system 100 may offer data buyers 300 the option to subscribe to user datasets. As users accumulate data over time, the journal system may update the subscribed datasets, and compensation arrangements may be adjusted accordingly. This subscription model provides continuous access to evolving user data, enhancing its value for buyers.

The journal system 100 may also include a feedback mechanism where data buyers 300 and users 200 can provide and receive feedback on the relevance and quality of the transacted data. Buyer feedback may be processed to refine future dataset categorization and improve the journal system's alignment with buyer needs.

By integrating robust search capabilities, transparent consent mechanisms, and secure transaction methods, journal system 100 is capable of delivering a seamless and ethical data monetization process. For example, a research organization conducting a clinical trial for hypertension medications may efficiently identify and acquire anonymized datasets from users meeting specific health and lifestyle criteria. This targeted approach may accelerate participant recruitment, reduce inefficiencies, and enhance research outcomes.

As shown in FIG. 4, according to another non-limiting exemplary embodiment, the user data 202 may be curated to create a dataset 102 for publication, either as part of a subscription-based model or a non-subscription-based model, at the user's choosing. For example, the user's journal entries 202 relating to the user's dreams may be curated into dataset 102, documenting and analyzing the user's dream experiences over time. This curated dataset 102 may include the content of the dreams themselves, such as narratives, recurring symbols, emotions experienced, and other significant elements noted by the user during journal entry. Additionally, the dataset may incorporate metadata such as the frequency of dreaming, timing (e.g., early or late REM sleep cycles), and external factors (e.g., recent stress, dietary changes, or medication intake) that may influence dream patterns.

At the user's discretion, the curated dataset may also include dream analyses, powered by the data processing system 101. Users may select from various schools of thought for analyzing their dreams, such as Freudian analysis, focusing on the latent and manifest content of dreams, including unconscious desires, repressed memories, or symbolic interpretations of dream imagery; Jungian analysis, exploring archetypes, the collective unconscious, and personal growth aspects tied to recurring themes or figures in dreams; or modern cognitive approaches, applying neuroscience or psychological theories, such as linking dreams to memory processing, problem-solving, or emotional regulation. The journal system 100 may allow users to combine elements from different analytical approaches, offering a personalized and comprehensive view of their dream data.

The curated dataset 102 may be summarized into an abstract format, highlighting key attributes for potential subscribers. For example, the abstract for dream journal may include: Demographic information of the user (e.g., age, gender, general location); dream frequency and recurring themes (e.g., “Recurring themes of flying or being pursued”); common symbols or emotions identified across entries (e.g., “Dreams frequently involve water, indicating feelings of uncertainty”); and, analytical insights (e.g., “Freudian analysis suggests unresolved desires).

Subscribers (data buyers) 300 may include any individual interested in the curated dataset 102. These subscribers 300 may include, but are not limited to, researchers, therapists, writers, artists, and hobbyists who have a personal or professional interest in dream analysis or related fields. These data buyers 300 may subscribe to the dataset 102 under mutually agreed-upon terms and conditions, including the frequency of updates, specific analytical approaches used in dream analysis, and compensation details. Alternatively, the curated dataset 102 may be made available for one-time purchase or other non-subscription-based arrangements.

The journal system 100 may also allow data buyers 300 to provide feedback to refine the curated dataset 102, ensuring it remains aligned with their interests and objectives.

By providing options for subscription-based or non-subscription-based publication, the present invention ensures flexibility for users in monetizing their curated dataset 102 while broadening the potential audience for publication to include any individual interested in exploring the curated dataset 102.

The present invention incorporates a comprehensive security and privacy framework to protect user data 102 throughout the processes of generation, analysis, curation, and transactions. Data anonymization techniques may be employed to remove personally identifiable information (PII) before datasets are shared with buyers. These techniques may include generalizing sensitive details, aggregating data, and tokenizing identifiers to ensure user anonymity while preserving data utility.

To safeguard data at all stages, the system may implement encryption protocols, such as AES-256, for both data in transit and at rest. Secure communication methods like SSL or TLS may protect data exchanges between user devices, the platform, and data buyers. Controlled access measures, including role-based access controls, may restrict access to datasets, ensuring that users retain control over what data is shared, with whom, and for what purpose.

User consent mechanisms may ensure transparency and control, allowing users 200 to approve or deny data transactions. Consent may be granular, enabling users to specify which data types or categories may be shared. Additionally, users 200 may update or revoke their consent preferences at any time, ensuring their data is handled according to their wishes. Compliance with data privacy regulations, such as GDPR or CCPA, further guarantees that users' rights are respected, including rights to access and delete their data.

The system may also utilize advanced technologies like ledger-based audit mechanisms, including but not limited to blockchain for auditability, creating immutable records of data transactions and access logs. Fraud detection algorithms may monitor for suspicious activities, such as unauthorized access attempts or efforts to re-identify anonymized data. By integrating these robust security and privacy measures, the present invention provides a reliable platform for data monetization, ensuring user trust and compliance with industry standards.

1. A method for personal data collection, management, and monetization, the method comprising the steps of: receiving user data from at least one user having at least one data-generating device; transmitting the user data to a data processing system configured to analyze and categorize the user data into at least one dataset; enabling user interaction with the data processing system; and enabling a transaction of the user dataset between the user and at least one data buyer.

2. The method of claim 1, wherein the data processing system employs artificial intelligence (AI) to categorize user data into thematic segments.

3. The method of claim 2, wherein the AI analyzes historical user data to generate predictive insights and recommendations.

4. The method of claim 1, wherein the user interaction with the data processing system includes receiving automated prompts for data entry.

5. The method of claim 1, wherein the transaction comprises an arrangement between the user and the data buyer, allowing the data buyer to selectively access the categorized dataset.

6. The method of claim 5, wherein the transaction arrangement between the user and the data buyer is content licensing.

7. The method of claim 5, wherein the transaction is facilitated through a subscription model that provides continuous access to updated datasets.

8. The method of claim 1, wherein the categorized dataset includes metadata indicating the accuracy, completeness, and reliability of the data.

9. The method of claim 1, further comprising a privacy control mechanism enabling users to define data sharing permissions before a transaction occurs.

10. The method of claim 9, wherein the privacy control mechanism includes anonymization techniques to protect user identity.

11. The method of claim 1, further comprising a secure audit log tracking all transactions of user data to ensure transparency and regulatory compliance.

12. A system for personal data collection, management, and monetization, the system comprising: at least one data-generating device configured to collect user data; a data processing system communicatively connected to the data-generating device, the data processing system configured to analyze and categorize the user data into at least one dataset; a user interface enabling user interaction with the data processing system; and a data transaction platform configured to facilitate transactions of the user dataset between the user and at least one data buyer.

13. The system of claim 12, wherein the data processing system employs artificial intelligence (AI) to categorize user data into thematic segments.

14. The system of claim 13, wherein the AI analyzes historical user data to generate predictive insights and recommendations.

15. The system of claim 13, wherein the user interface is configured to provide automated prompts for data entry.

16. The system of claim 13, wherein the data transaction platform enables an arrangement between the user and the data buyer, allowing the data buyer to selectively access the categorized dataset.

17. The system of claim 16, wherein the transaction arrangement between the user and the data buyer is content licensing.

18. The system of claim 16, wherein the transaction is facilitated through a subscription model that provides continuous access to updated datasets.

19. The system of claim 12, wherein the categorized dataset includes metadata indicating the accuracy, completeness, and reliability of the data.

20. The system of claim 12, further comprising a privacy control mechanism enabling users to define data sharing permissions before a transaction occurs.

21. The system of claim 20, wherein the privacy control mechanism includes anonymization techniques to protect user identity.

22. The system of claim 12, further comprising a secure audit log tracking all transactions of user data to ensure transparency and regulatory compliance.
